(19) United States
(12) Patent Application Publication
(10) Pub. No.: US 2003/0007686 A1
(43) Pub. Date: Jan. 9, 2003

(54) Combined color space matrix transformation and FIR filter

(76) Inventor: Jens A. Roever, Cupertino, CA (US)

Correspondence Address: Corporate Patent Counsel, U.S. Philips Corporation, 580 White Plains Road, Tarrytown, NY, 10591, US

(21) Appl. No.: 09/895,905

(22) Filed: Jun. 29, 2001

(51) Int. Cl. G06K 9/00; G06K 9/40; G06K 9/32

(52) U.S. Cl. 382/167; 382/298; 382/260

(57) ABSTRACT

The same circuitry is used for effecting FIR filtering and color space transformation. The input to a multiply-add array of a conventional FIR filter is appropriately multiplexed to provide the alternative uses of the same multiply-add array. In this manner, for example, the same multiply-add array can be used for scaling an image and for transforming the image from one color space to another.

### BACKGROUND OF THE INVENTION

1. Field of the Invention

This invention relates to the field of video processing, and in particular to a video processor that includes a color space matrix transformation and finite impulse response (FIR) filter.

2. Description of Related Art

FIR Filters

Finite impulse response (FIR) filters are commonly used in video processing systems for filtering picture element (pixel) values, particularly pixel values that are produced when an image is scaled or otherwise transformed from its original form. For example, a decimation, or downsampling, of an image to produce a 4:1 reduction in image size can be effected by merely choosing every fourth input pixel value to provide each output pixel value. Such a sampling, however, will generally produce visual anomalies and/or discontinuities, as the particular pixel value selected may not be representative of the non-selected pixel values. An FIR filter provides for a weighted averaging of a plurality of pixel values to produce each pixel value, thereby reducing the anomalies and discontinuities that may occur with non-filtered scaling. In an upscaling application, wherein multiple output samples are produced for each input sample, the weighted averaging provides for an interpolated value for each output sample, wherein the inclusion of pixel values beyond the immediately adjacent input samples provides for a less-artificial-appearing filling of values between the input samples.

A common FIR structure for video processing is a six-tap, three-component filter that provides an output pixel value that is a dependent upon six input pixel values, each pixel value being represented by three components, such as red-green-blue components in an RGB color space. In a conventional six-tap three-component FIR filter, the following transformation is effected:

$$[ \begin{matrix}{a}_{0}^{′} \\ {a}_{1}^{′} \\ {a}_{2}^{′}\end{matrix} ] = [ \begin{matrix}{c}_{00} & {c}_{01} & {c}_{02} & {c}_{03} & {c}_{04} & {c}_{05} \\ {c}_{10} & {c}_{11} & {c}_{12} & {c}_{13} & {c}_{14} & {c}_{15} \\ {c}_{20} & {c}_{21} & {c}_{22} & {c}_{23} & {c}_{24} & {c}_{25}\end{matrix} ] \times [ \begin{matrix}{a}_{0}^{0} & {a}_{1}^{0} & {a}_{2}^{0} \\ {a}_{0}^{- 1} & {a}_{1}^{- 1} & {a}_{2}^{- 1} \\ {a}_{0}^{- 2} & {a}_{1}^{- 2} & {a}_{2}^{- 2} \\ {a}_{0}^{- 3} & {a}_{1}^{- 3} & {a}_{2}^{- 3} \\ {a}_{0}^{- 4} & {a}_{1}^{- 4} & {a}_{2}^{- 4} \\ {a}_{0}^{- 5} & {a}_{1}^{- 5} & {a}_{2}^{- 5}\end{matrix} ] + [ \begin{matrix}{e}_{0} \\ {e}_{1} \\ {e}_{2}\end{matrix} ]$$

In the above equation, aᵢ^{j} corresponds to the i^{th} component of the j^{th} pixel value, c₀₀-c₂₅ are the coefficients, or weights, for providing the weighted average, and e₀-e₃ are the translation, or offset, terms applied to each output pixel component value a′₀-a′₃. Additional processing, including quantization, rounding, clamping, etc. are also subsequently applied, but are not illustrated herein, for ease of understanding.

Note that, for effective filtering, an FIR filter of at least 3 taps, and preferably 6 or more taps are generally employed. At least eighteen multipliers and adders are required to effect the example 6-tap 3-component FIR filter.

Color Space Transformation

Generally, different video processing applications employ different color space representations of the pixel values. For example, computer systems generally employ an RGB (red-green-blue) color space, wherein each pixel value is represented by a red component, a green component, and a blue component. A conventional broadcast television signal, on the other hand, encodes images using a luminance component (Y) and two chrominance components (U and V) corresponding to a YUV color space. A quadrature variation of YUV is the YIQ color space. The YCbCr color space is a scaled version of YUV that is used in digital video encodings. Other color space representations of an image are also common in the art. In VIDEO DEMYSTIFIED, by Keith Jack, published in 1966 by HighText Interactive, Inc. of San Diego, Calif., eight different color space standards are presented, with equations for converting from one color space to another.

In traditional systems that support more than one color space, the transformation between color spaces is typically effected via hardware that is customized for the particular color space transformation. A customized design allows for a reduction in circuitry and the required area for this circuitry on an integrated circuit, but limits the applicability of the design to the particular color space transformation. If multiple transformations are intended to be supported, a matrix transformation structure is generally employed:

$$[ \begin{matrix}{A}_{0}^{′} \\ {A}_{1}^{′} \\ {A}_{2}^{′}\end{matrix} ] = [ \begin{matrix}{C}_{00} & {C}_{01} & {C}_{02} \\ {C}_{10} & {C}_{11} & {C}_{12} \\ {C}_{20} & {C}_{21} & {C}_{22}\end{matrix} ] \times [ \begin{matrix}{A}_{0} + {D}_{0} \\ {A}_{1} + {D}_{1} \\ {A}_{2} + {D}_{2}\end{matrix} ] + [ \begin{matrix}{B}_{0} \\ {B}_{1} \\ {B}_{2}\end{matrix} ]$$

where A₀-A₂ are the component values of the input pixel in the input color space, A′₀-A′₂ are the component values of the output pixel in the output color space, D₀-D₂ are the offsets associated with the input color components, B₀-B₂ are the offsets associated with the output color components, and C₀₀-C₂₂ are the coefficients of the particular transformation equation. For example, the conversion between conventional RGB and YCbCr color spaces is effected via the following equations.

From an input pixel having R-G-B component values to an output pixel having Y-Cb-Cr component values:

$$[ \begin{matrix}Y \\ Cb \\ Cr\end{matrix} ] = [ \begin{matrix}0.257 & 0.504 & 0.098 \\ - 0.148 & - 0.291 & 0.439 \\ 0.439 & - 0.368 & - 0.071\end{matrix} ] \times [ \begin{matrix}R \\ G \\ B\end{matrix} ] + [ \begin{matrix}16 \\ 128 \\ 128\end{matrix} ]$$

From an input pixel having Y-Cb-Cr component values to an output pixel having R-G-B component values:

$$[ \begin{matrix}R \\ G \\ B\end{matrix} ] = [ \begin{matrix}1.164 & 0 & 1.596 \\ 1.164 & - 0.392 & - 0.813 \\ 1.164 & 0 & 2.017\end{matrix} ] \times [ \begin{matrix}Y - 16 \\ Cb - 128 \\ Cr - 128\end{matrix} ] + [ \begin{matrix}0 \\ 0 \\ 0\end{matrix} ]$$

In a system that is configured to provide multiple color-space transformations, the different input-to-output color space transformations are performed by loading the appropriate coefficients and offsets to a 3×3 matrix multiplier and adder. Note that such an embodiment requires at least nine multipliers and adders, in addition to a preprocessor that subtracts the appropriate offsets (D₀, D₁, D₂) from the input components (e.g. Y-16, Cb-128, and Cr-128) of particular color spaces.

### BRIEF SUMMARY OF THE INVENTION

It is an object of this invention to reduce the circuitry and area required to effect color space transformation. It is a further object of this invention to optimize the use of the circuitry provided for FIR filtering.

These objects and others are achieved by using the same circuitry for effecting FIR filtering and color space transformation. The input to a multiply-add array of a conventional FIR filter is appropriately multiplexed to provide the alternative uses of the FIR filter components. In this manner, for example, the same multiply-add array of components can be used for scaling an image and for transforming the image from one color space to another.

### BRIEF DESCRIPTION OF THE DRAWINGS

The invention is explained in further detail, and by way of example, with reference to the accompanying drawings wherein:

FIG. 1 illustrates an example block diagram of a video processing system in accordance with this invention.

FIG. 2 illustrates an example block diagram of a multi-use FIR filter combination in accordance with this invention.

Throughout the drawings, the same reference numerals indicate similar or corresponding features or functions.

### DETAILED DESCRIPTION OF THE INVENTION

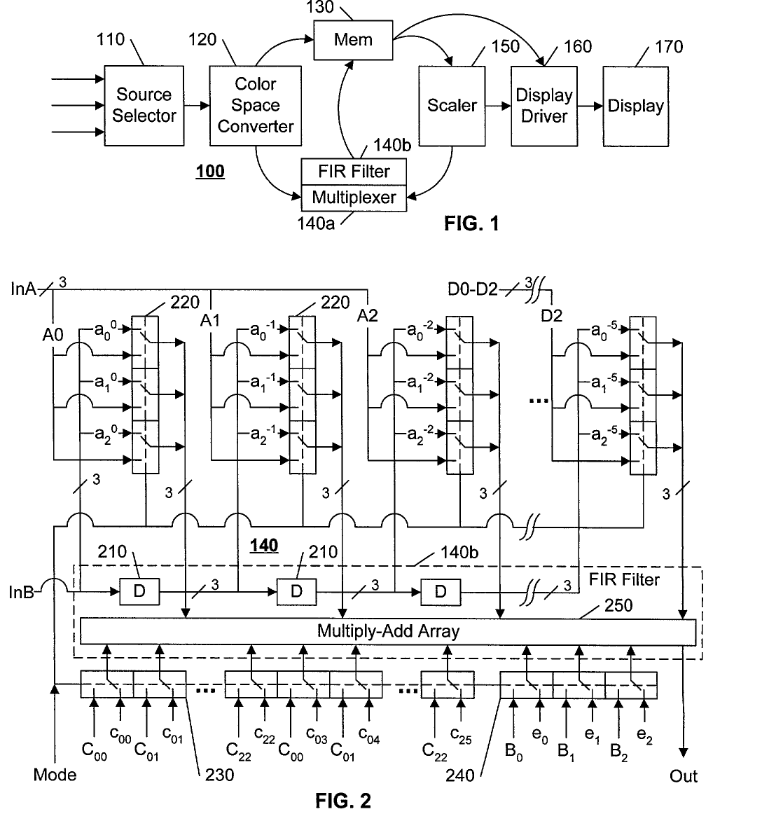

FIG. 1 illustrates an example block diagram of an image processing system 100 in accordance with this invention. The processing system 100 is presented as an example application of this invention, although one of ordinary skill in the art will recognize that the invention is not limited to this example application. The processing system 100 allows multiple input image sources, of different formats, and in particular, images having pixel values using different color-space encodings. A source selector 110 selects a particular input image source, and provides the select image to a color-space converter 120. In this example, to minimize design complexity, the color-space converter 120 is configured to convert, as necessary, pixel encodings in one color space to an encoding in a particular color space that the remainder of the system is configured to process. That is, for example, in a computer-based display system, a number of utility processes and application programs exist that are based on an RGB color space encoding. For example, image enhancement schemes that are configured to sharpen images, or remove noise from images, are commonly available for processing RGB encoded images. By converting other color space encodings into an RGB encoding, these existing utility processes and application programs can be employed. In a conventional image processing system, the color space conversion function is provided by special purpose hardware or by a 3×3 matrix multiplication, as discussed in the background to this invention. In accordance with this invention, the color-space converter 120 is configured to employ the multiplication and addition components of an FIR filter 140b, discussed further below.

As is common in the art, in the example image processing system 100, a memory 130 is used to communicate the image data among processing blocks. This memory 130 may include, for example, line buffers for individual lines in the image, frame memory for sequential images, cache memory, and so on. In this example, the color space converter 120 is configured to provide the source image data to the FIR filter 140b, and the FIR filter 140b is configured to place the color-space-converted data in the memory 130.

A scaler 150 is configured to provide optional scaling of the image from the memory 130. In accordance with this invention, the example scaler 150 is configured to use the same multiply-add array of an FIR filter 140b as the color-space converter 120, via a multiplexer 140a, as discussed further below. In this example, the scaled version of the image, from the FIR filter 140b, is also stored in the memory 130, for subsequent processing by a display driver 160 for presentation of the image on a display 170. Note that other processes, such as quantization, rounding, clamping, sharpening, and so on may be applied to the scaled or unscaled data that is in the memory 130, as is common in the art, but are not illustrated in FIG. 1, for ease of understanding.

A multiplexer 140a selects whether the input to the FIR filter 140b is from the color-space converter 120, or the scaler 150. Depending upon the particular configuration and supported functions of the processing system 100, the multiplexer 140a may introduce constraints on the use of the FIR filter 140b. For example, for maximum throughput of the system 100, the multiplexer 140a may be configured such that only one function, color-space-conversion or image-scaling, may be applied for a given input stream. That is, for example, in an RGB-based system, scaling may be provided only for images that are provided from an RGB source, which does not require color-space conversion. If throughput is not critical, the system 100 may be configured to set the multiplexer 140a to convert each input image to the select color-space, and, after the image is converted, to set the multiplexer 140a to scale the color-space-converted image. Other multiplexing schemes will be evident to one of ordinary skill in the art in view of this disclosure. For example, the system may be configured to control the multiplexer 140a so that data from the converter 120 and scaler 150 are alternately processed, thereby allowing continuous processing, albeit at a slower rate than a system that limits the processing by the FIR filter 140b to one input or the other for the entire process.

FIG. 2 illustrates an example block diagram of a multi-use FIR filter combination 140 in accordance with this invention. The FIR filter combination 140 comprises the aforementioned FIR filter 140b, and a plurality of multiplexers 220, 230, 240, that are represented in FIG. 1 as the multiplexer 140a.

In accordance with this invention, the multiplexers 220, 230, 240 are configured to provide an appropriate input to the FIR filter 140b to effect the intended transformation. In the example of FIG. 2, the input InB corresponds to the conventional input to an FIR filter to effect a scaling function, as discussed above with regard to the 6-tap, 3-component FIR filter that provides the following matrix operation:

$$[ \begin{matrix}{a}_{0}^{′} \\ {a}_{1}^{′} \\ {a}_{2}^{′}\end{matrix} ] = [ \begin{matrix}{c}_{00} & {c}_{01} & {c}_{02} & {c}_{03} & {c}_{04} & {c}_{05} \\ {c}_{10} & {c}_{11} & {c}_{12} & {c}_{13} & {c}_{14} & {c}_{15} \\ {c}_{20} & {c}_{21} & {c}_{22} & {c}_{23} & {c}_{24} & {c}_{25}\end{matrix} ] \times [ \begin{matrix}{a}_{0}^{0} & {a}_{1}^{0} & {a}_{2}^{0} \\ {a}_{0}^{- 1} & {a}_{1}^{- 1} & {a}_{2}^{- 1} \\ {a}_{0}^{- 2} & {a}_{1}^{- 2} & {a}_{2}^{- 2} \\ {a}_{0}^{- 3} & {a}_{1}^{- 3} & {a}_{2}^{- 3} \\ {a}_{0}^{- 4} & {a}_{1}^{- 4} & {a}_{2}^{- 4} \\ {a}_{0}^{- 5} & {a}_{1}^{- 5} & {a}_{2}^{- 5}\end{matrix} ] + [ \begin{matrix}{e}_{0} \\ {e}_{1} \\ {e}_{2}\end{matrix} ]$$

As illustrated in the example of FIG. 2, a series of delay elements 210 in the FIR filter 140b provide the a⁰, a⁻⁰, . . . a⁻⁵ pixel values, corresponding, for example, to a series of pixel values comprising a six-pixel length of a horizontal line. The coefficients c₀₀-C₂₅ and offsets e₀-e₃ are set by the scaler 150 (of FIG. 1), based on the scaling factor and phase of the input and output pixel values, using algorithms that are common in the art. The above matrix multiplication and addition is effected via an array of multipliers and adders 250, as is common in the art for conventional FIR filters.

To provide color-space conversion of an input InA to the multiplexed FIR filter system 140, the conventional 3×3 matrix operation is provided by the example 6-tap, 3-component FIR filter as follows.

As presented above, the conventional 3×3 color-space conversion is provided by:

$$[ \begin{matrix}{A}_{0}^{′} \\ {A}_{1}^{′} \\ {A}_{2}^{′}\end{matrix} ] = [ \begin{matrix}{C}_{00} & {C}_{01} & {C}_{02} \\ {C}_{10} & {C}_{11} & {C}_{12} \\ {C}_{20} & {C}_{21} & {C}_{22}\end{matrix} ] \times [ \begin{matrix}{A}_{0} + {D}_{0} \\ {A}_{1} + {D}_{1} \\ {A}_{2} + {D}_{2}\end{matrix} ] + [ \begin{matrix}{B}_{0} \\ {B}_{1} \\ {B}_{2}\end{matrix} ] .$$

This conventional 3×3 color-space conversion can be shown to be equivalent to:

$$[ \begin{matrix}{A}_{0}^{′} \\ {A}_{1}^{′} \\ {A}_{2}^{′}\end{matrix} ] = [ \begin{matrix}{C}_{00} & {C}_{01} & {C}_{02} \\ {C}_{10} & {C}_{11} & {C}_{12} \\ {C}_{20} & {C}_{21} & {C}_{22}\end{matrix} \begin{matrix}{C}_{00} & {C}_{01} & {C}_{02} \\ {C}_{10} & {C}_{11} & {C}_{12} \\ {C}_{20} & {C}_{21} & {C}_{22}\end{matrix} ] \times [ \begin{matrix}{A}_{0} & {A}_{0} & {A}_{0} \\ {A}_{1} & {A}_{1} & {A}_{1} \\ {A}_{2} & {A}_{2} & {A}_{2} \\ {D}_{0} & {D}_{0} & {D}_{0} \\ {D}_{1} & {D}_{1} & {D}_{1} \\ {D}_{2} & {D}_{2} & {D}_{2}\end{matrix} ] + [ \begin{matrix}{B}_{0} \\ {B}_{1} \\ {B}_{2}\end{matrix} ] .$$

That is, the 3×3 color-space conversion coefficient matrix C₀₀-C₂₂ is duplicated to fill the 6×3 FIR filter coefficient matrix, and the input values A₀-A₂ and offsets D₀-D₂ are provided as discrete entries. The YCbCr to RGB color-space conversion as presented in the background of the invention, for example, is recast to:

$$[ \begin{matrix}R \\ G \\ B\end{matrix} ] = [ \begin{matrix}1.164 & 0 & 1.596 & 1.164 & 0 & 1.596 \\ 1.164 & - 0.392 & - 0.813 & 1.164 & - 0.392 & - 0.813 \\ 1.164 & 0 & 2.017 & 1.164 & 0 & 2.017\end{matrix} ] \times [ \begin{matrix}Y & Y & Y \\ Cb & Cb & Cb \\ Cr & Cr & Cr \\ - 16 & - 16 & - 16 \\ - 128 & - 128 & - 128 \\ - 128 & - 128 & - 128\end{matrix} ] + [ \begin{matrix}0 \\ 0 \\ 0\end{matrix} ]$$

By recasting the conventional 3×3 color-space conversion matrix operation to a 6×3 FIR filter matrix, the multiplexers 220, 230, 240 can be configured to provide the appropriate inputs to the example 6×3 FIR filter 140b of FIG. 2. As illustrated, when the mode signal is asserted to an opposite state to the state used to effect the conventional FIR filter function, the inputs to the multiply-add array 250 of the FIR filter 140b are switched by the multiplexer to provide the appropriate input values A₀-A₂, output-offset values B₀-B₂ duplicated coefficient values C₀₀-C₂₂, and input-offsets D₀-D₂ to the 6×3 multipliers and adders to effect the 6×3 color-transformation matrix operation presented above. Note that, although the 3×3 color space transformation is effected by a 3×6 multiply-add array 250, which is substantially larger than the conventional 3×3 multiply-add array that is typically used to effect a 3×3 matrix operation, a savings in circuit-area is achieved, because the multiplexers 220, 230, 240 can be expected to consume less area than a conventional 3×3 multiply-add array.

As would be evident to one of ordinary skill in the art, if a different sized FIR filter 140b is provided, the 3×3 color-space conversion matrix operation is recast as required to conform to the different sized FIR filter. A 4×4 FIR filter can be used, for example, by filling the parameters of the 3×3 color-space matrix directly into the 3×3 subset of the 4×4 FIR filter, and zero-filling the unused inputs.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. An image processing system comprising:
a color-space converter that is configured to provide a conversion of pixel values in a first color-space to corresponding pixel values in a second color-space,
a scaler that is configured to provide a scaling of pixel values at a first scale to corresponding pixel values at a second scale, and
a filter that is configured to apply a filter function to pixel values;
wherein
the color-space converter uses the filter to provide the conversion, and
the scaler uses the filter to provide the scaling.

2. The image processing system of claim 1, further including
a first multiplexer that is configured to selectively provide pixel values to the filter to selectively effect the conversion and the scaling.

3. The image processing system of claim 2, further including
a second multiplexer that is configured to selectively provide color-space-conversion coefficients and scaling coefficients to the filter to selectively effect the conversion and the scaling.

4. The image processing system of claim 3, wherein
a third multiplexer that is configured to selectively provide offset parameters to the filter to selectively effect the conversion and the scaling.

5. The image processing system of claim 1, wherein
the filter is an FIR filter.

6. The image processing system of claim 1, further including
a memory that facilitates communication of pixel values among the color-space converter, the scaler, and the filter.

7. The image processing system of claim 1, wherein
the filter is a 6-tap, 3-element FIR filter.

8. The image processing system of claim 1, wherein
the filter includes a multiply-add array, and
the color-space converter uses the multiply-add array of the filter to provide the conversion, and
the scaler uses the multiply-add array of the filter to provide the scaling.

9. A processing system comprising:
a multiply-add array that includes:
six data inputs, each data input including three element inputs, and eighteen coefficient inputs;
the multiply-add array being configured to effect a 3×6 matrix multiplication of the six data inputs and the eighteen coefficients to provide an output having three element outputs, and
a multiplexer, operably coupled to the multiply-add array that is configured to provide,
when the multiplexer is in a first selectable mode,
each of six pixel values, each having three component values, to each of the six data inputs; and
when the multiplexer is in a second selectable mode,
each of three components of a single pixel value to three of the six data inputs, each of the three components being provided to the three element inputs of each of the three data inputs, and
each of three offsets associated with the three components of the single pixel value to another three of the six data inputs, each of the three offsets being provided to the three element inputs of each of the another three data inputs.

10. The processing system of claim 9, wherein
the multiplexer is further configured to provide,
when the multiplexer is in the first selectable mode,
eighteen scaling coefficients to the eighteen coefficient inputs, to provide a scaled pixel value corresponding to the six pixel values as the output; and
when the multiplexer is in the second selectable mode,
nine color-space conversion coefficients to each of:
a first set of nine coefficient inputs of the eighteen coefficient inputs, and
a second set of another nine coefficient inputs of the eighteen coefficient inputs, to provide a color-space conversion of the single pixel value as the output.

11. The processing system of claim 10, wherein
the multiply-add array further includes:
three offset inputs, for offsetting each of the three element outputs; and
the multiplexer is further configured to provide,
when the multiplexer is in the first selectable mode,
three scaling offsets to the three offset inputs, to offset the scaled pixel value; and
when the multiplexer is in the second selectable mode,
three color-space offsets to the three offset inputs, to offset the color-space conversion of the single pixel value.
